(19) United States
(12) Patent Application Publication
(10) Pub. No.: US 2017/0350672 A1
(43) Pub. Date: Dec. 7, 2017

(54) VEHICLE MOUNTED FIREARM RETENTION DEVICE

(71) Applicant: Arthur W. Masteller, Anna, OH (US)

(72) Inventor: Arthur W. Masteller, Anna, OH (US)

(21) Appl. No.: 15/611,080

(22) Filed: Jun. 1, 2017

Related U.S. Application Data
(60) Provisional application No. 62/346,073, filed on Jun. 6, 2016.

(51) Int. Cl. F41C 33/04; B60R 7/14; F41C 33/02; B60R 11/00

(52) U.S. Cl. CPC F41C 33/043; F41C 33/0263; B60R 7/14; F41C 33/0236; B60R 2011/008

(57) ABSTRACT

Provided herein is a firearm retention device. The firearm retention device includes a base; an arm coupled to the base and pivotable about an axis of rotation; a cradle coupled to an end of the arm opposite the base and having an inner cavity shaped to receive a firearm therein; and a locking mechanism having a locking member, wherein the locking mechanism is positioned so that the locking member extends into a space formed by a trigger guard of the firearm when the firearm is received in the cradle and the locking member is moved to a locking position.

### CROSS-REFERENCE TO RELATED APPLICATIONS

This application claims the benefit of the filing date of U.S. Provisional Application No. 62/346,073, which was filed on Jun. 6, 2016. The contents of U.S. Application No. 62/346,073 are incorporated by reference in their entirety as part of this application.

### FIELD

This application relates generally to firearm retention devices/holsters, in particular vehicle mounted firearm retention devices.

### BACKGROUND

Law enforcement officers, military personnel, and/or firearm owners possessing a conceal carry permit often desire to have access to firearms while seated in a vehicle. In the case of law enforcement officers, access to a secondary firearm within the law enforcement vehicle may provide a tactical advantage to the law enforcement officer seated in the vehicle and faced with a potential threat from outside the vehicle. With traditional sidearm holsters commonly used by law enforcement officers, the holster, which is often engaged with a belt worn about the waist, positions the firearm with the butt of the firearm jammed into the backrest of the driver's seat when the law enforcement officer is seated in the driver's seat of the vehicle. With the butt of the weapon jammed into the backrest, the law enforcement officer cannot easily access the weapon while seated in the car. There is a need for a vehicle mounted holster that provides efficient access to firearms within a vehicle.

### SUMMARY

Provided herein is a firearm retention device. The firearm retention device includes a base; an arm coupled to the base and pivotable about an axis of rotation; a cradle coupled to an end of the arm opposite the base and having an inner cavity shaped to receive a firearm; and a locking mechanism having a locking member, wherein the locking mechanism is positioned so that the locking member extends into a space formed by a trigger guard of the firearm when the firearm is received in the cradle and the locking member is moved to a locking position.

In some embodiments, the arm of the firearm retention device has three pivot points about which the arm is pivotable.

The firearm retention device can also include a riser pivotably coupled to the base, a bracket pivotably coupled to the riser, and a hinge pivotably coupled to the bracket.

In some embodiments, the cradle has a first open end configured to receive a firearm and a second open end opposite the first open end and through which the barrel of the firearm protrudes. The cradle can also include a rigid outer shell and an insert positioned within the outer shell and shaped to receive the firearm.

The locking mechanism can include a solenoid coupled to the locking member and the solenoid can move the locking member out of the locking position when activated. In some embodiments, the locking mechanism includes one or more electrical connections for providing power from the vehicle to the locking mechanism. In some embodiments, the firearm retention device further includes a battery receptacle for receiving one or more batteries to provide power for the solenoid.

Further provided herein is a firearm retention device that includes a mounting base, a riser, a hinge, a mounting bracket, a cradle, and a locking mechanism. The riser is pivotably coupled to the base about a first axis. The hinge is pivotably coupled to the riser about a second axis and the second axis is substantially parallel to the first axis. The mounting bracket is pivotably coupled to the hinge about a third axis and the third axis is substantially perpendicular to the second axis. The cradle has an inner cavity shaped to receive a firearm and is pivotably coupled to the mounting bracket about a fourth axis and the fourth axis is substantially perpendicular to the third axis and the second axis. The locking mechanism has a locking member movable between a locking position and an unlocking position, wherein the locking member is received within a trigger guard of the firearm when the firearm is received in the cradle and the locking member is moved to the locking position.

### BRIEF DESCRIPTION OF THE DRAWINGS

The components in the drawings are not necessarily to scale. Moreover, in the drawings, like reference numerals designate corresponding parts throughout the several views.

FIG. 1 is a perspective view of one embodiment of a firearm retention device as disclosed herein.

FIG. 2 is a perspective view of the firearm retention device of FIG. 1 deployed in a vehicle.

FIG. 3 is a front perspective view of another embodiment of a firearm retention device with the firearm removed.

FIG. 4 is a side perspective view of the firearm retention device of FIG. 3 with the firearm installed.

FIG. 5 is a top view of a riser portion of the firearm retention device of FIG. 3 with the riser portion coupled to the base.

FIG. 6 is a front view of a positioning bracket of the firearm retention device of FIG. 3.

FIG. 7 is a top view of the positioning bracket of FIG. 6.

FIG. 8 is a side view of the positioning bracket of FIG. 6.

FIG. 9 is a side view of the positioning hinge of the positioning bracket of FIG. 6 having the shaft removed from the outer housing.

FIG. 10 is a top view of a cradle of the firearm retention device of FIG. 3.

FIG. 11 is a side view of the cradle of the firearm retention device of FIG. 3.

FIG. 12 is a sectional view of the cradle of FIG. 11 taken along section line AA.

FIG. 13 is a sectional view of the cradle of FIG. 11 taken along section line BB.

FIG. 14 is a schematic showing the electrical connection of the solenoid of the locking mechanism to a power source, switch, and time delay relay.

### DETAILED DESCRIPTION

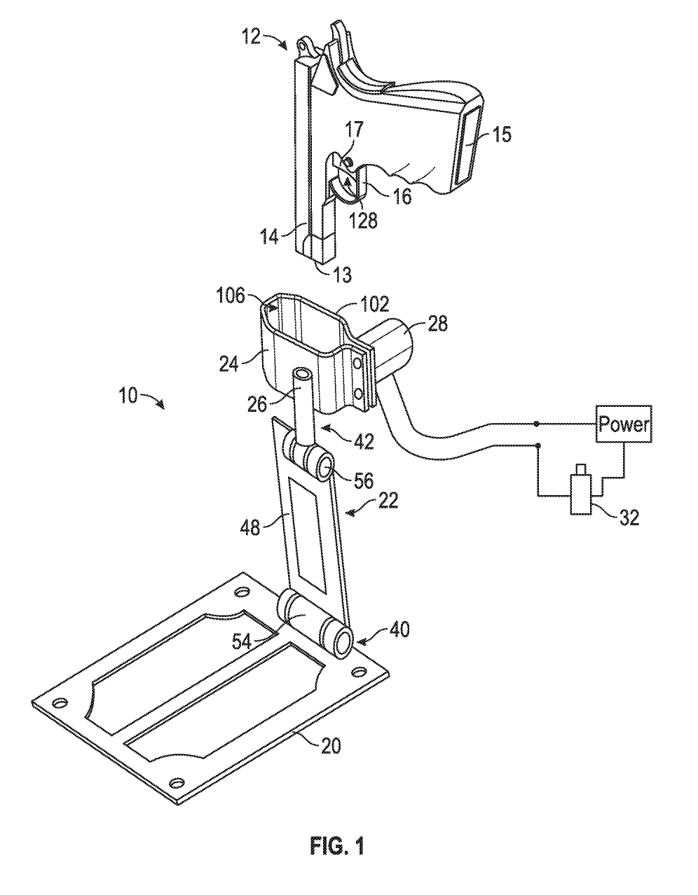

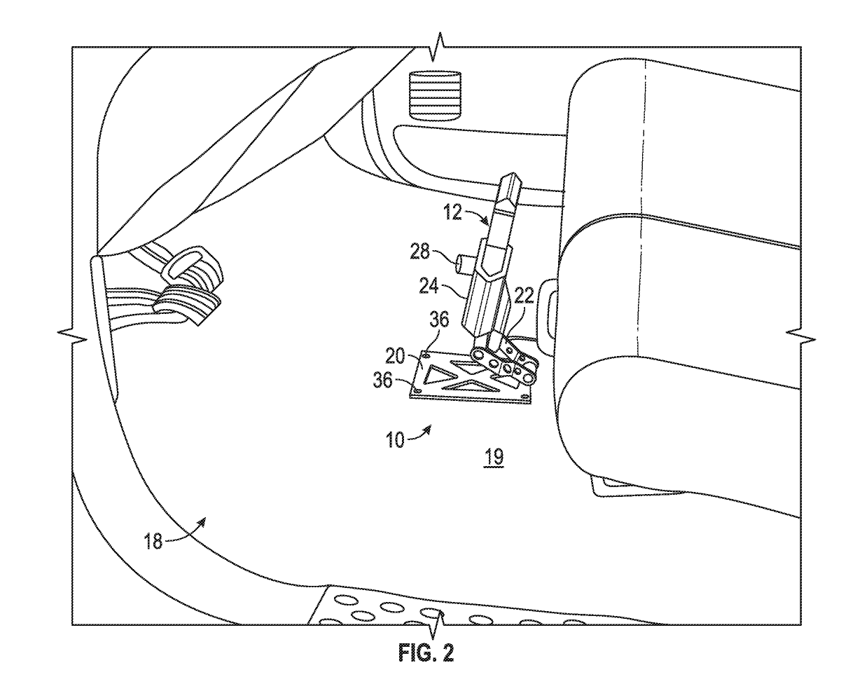

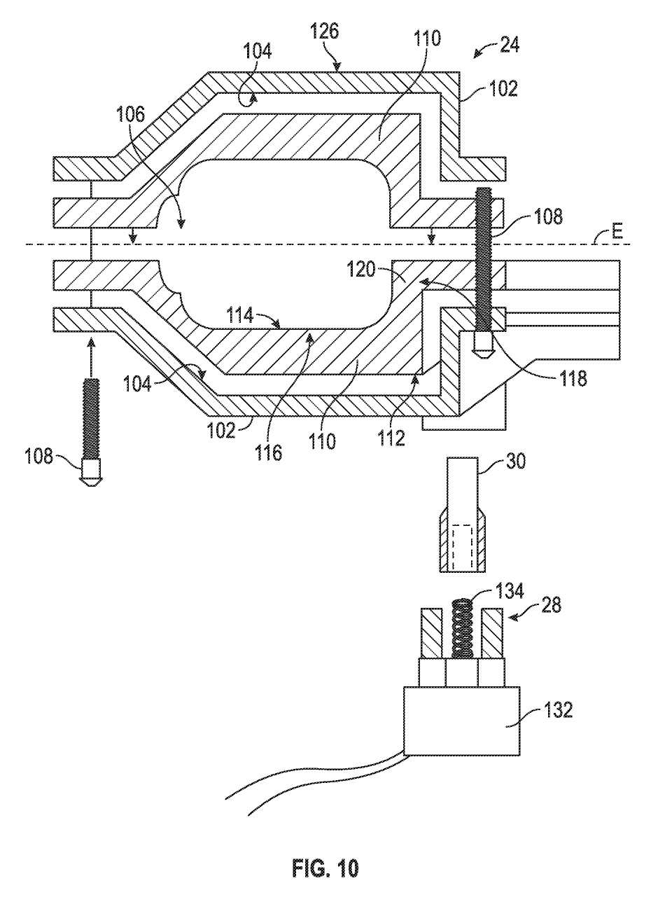

Referring to FIGS. 1-2, a firearm retention device, referred to herein by the reference number 10, is disclosed for retaining a firearm 12, such as a handgun, in a vehicle 18 and providing efficient access to the firearm 12. The firearm retention device 10 includes a base 20, which may be a mounting plate, an adjustable arm 22 coupled to the base 20 and pivotable about one or more axis of rotation, and a cradle 24 coupled to an end 26 of the arm opposite the base 20. The cradle 24 is shaped to receive the barrel 14 of the firearm 12 and includes a locking mechanism 28 having a locking member 30 (FIG. 10). The locking mechanism 28 can be coupled to the cradle 24 and positioned such that the locking member 30 engages a trigger guard 16 of the firearm 12 when the locking mechanism 28 is in a locked position. The locking mechanism 28 can include a release device 32 to disengage the locking member 30 for inserting the firearm 12 into or removing the firearm 12 from the cradle 24. The adjustable arm 22 enables the cradle 24 to be positioned in an efficient and ergonomic position within the vehicle 18 when the vehicle operator is seated in the vehicle 18. The locking mechanism 28 keeps the firearm 12 secured within the vehicle 18 but allows efficient release of the firearm 12 when needed.

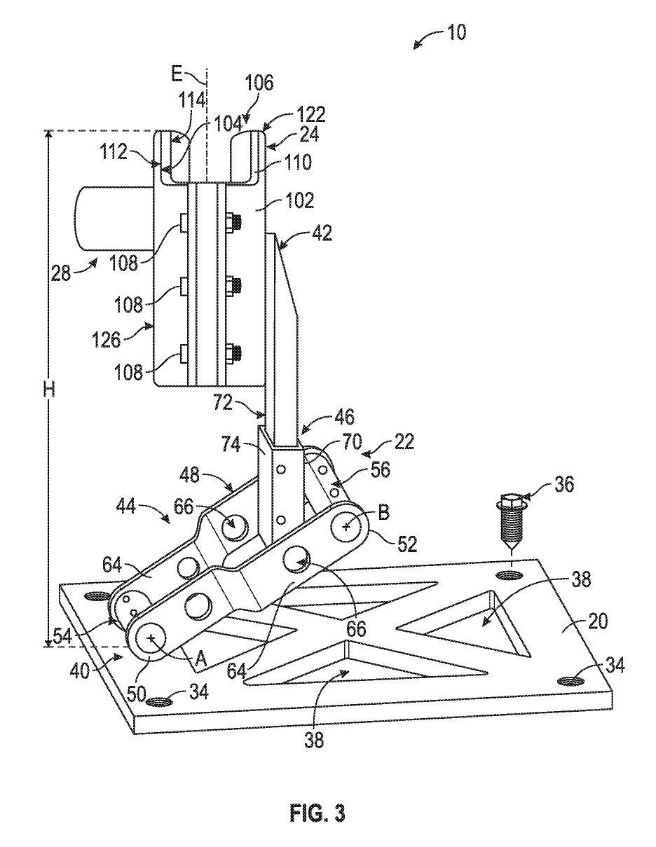

Referring to FIG. 3, the base 20 (mounting plate) can be a flat plate having a plurality of mounting holes 34 therethrough for coupling the base 20, and thus the firearm retention device 10, to a surface of the vehicle 18 or other anchor point. Each of the mounting holes 34 can be sized to receive a fastener 36 therethrough for mounting the base plate 20 to the vehicle 18. In one embodiment, the mounting holes 34 may be threaded. The base 20 can also have one or more openings 38 therethrough to reduce the quantity of material in the base 20 and reduce the weight of the base 20. The base 20 can have any convenient shape in top view, including square, rectangular, circular, triangular, polygonal, elliptical or other shape. The base 20 can be made of a rigid and durable material, such as, for example, carbon fiber, fiberglass, or metal, such as steel, iron, aluminum, titanium, brass or other metal or metal alloy. The base 20 can also be made of a rigid and/or durable thermoplastic or polymer, such as acrylonitrile butadiene styrene (ABS), polyethylene (PE), high-density/low-density polyethylene (HDPE/LDPE), polypropylene (PP), polyamide, polystyrene (PS), poly vinyl chloride (PVC), or other rigid or durable plastic/polymeric material or composite materials.

Referring to FIGS. 1-2, the arm 22 is coupled to the base 20 at a proximal end 40 and coupled to the cradle 24 at a distal end 42. The arm 22 is adjustable about one or more axis of rotation (or pivot points) so that the arm 22 is adjustable in one or more dimensions to position the cradle 24 for efficient and ergonomic access by the operator of the vehicle 18. In one embodiment, the arm 22 is adjustable in three dimensions. The arm 22 can include two or more axis of rotation in one embodiment, three or more axis of rotation in another embodiment, or four or more axis of rotation in yet another embodiment.

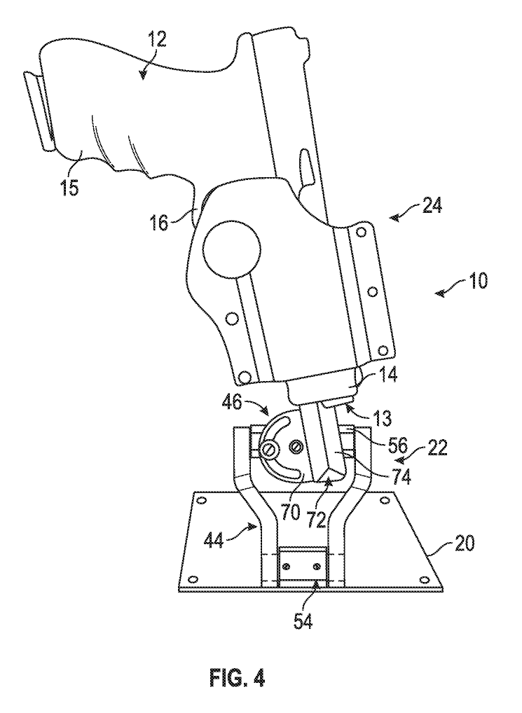

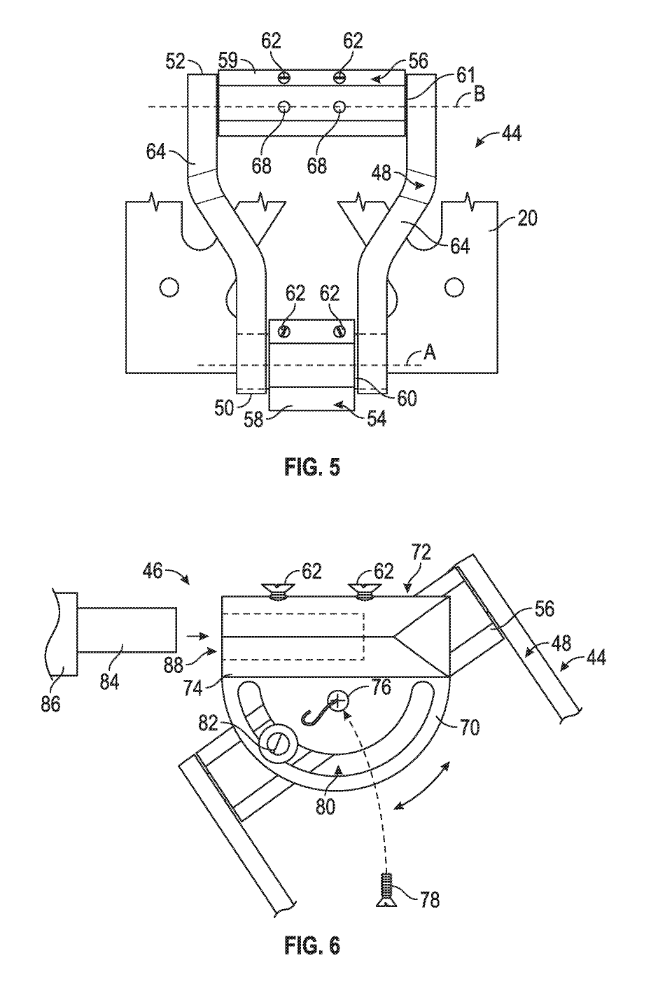

Referring to FIGS. 3-4, the arm 22 can include a riser 44 for adjusting a height H of the cradle 24 relative to the base 20 and a positioning bracket 46 for orienting the cradle 24 in an efficient and ergonomic position for access by the vehicle driver. Referring to FIG. 5, the riser 44 can include at least one extension 48 having a proximal end 50 and a distal end 52 and at least two riser hinges 54, 56, which include at least a proximal riser hinge 54 positioned at the proximal end 50 of the extension 48 and a distal riser hinge 56 positioned at the distal end 52 of the extension 48.

Referring to FIG. 5, each of the proximal 54 and distal 56 riser hinges can include an outer housing 58, 59 defining a cylindrical interior cavity (not shown) extending axially through the outer housing 58, 59. A shaft 60, 61 of each riser hinge 54, 56 can be a cylindrical shaft extending through the interior cavity of the outer housing 58, 59 and having center axis A, B. The outer housing 58, 59 of each riser hinge 54, 56 can be generally concentric about the shaft 60, 61 and can have one or more set screws 62 received through threaded openings in the outer housing 58, 59 and engageable with the shaft 60, 61 of the riser hinge 54, 56 to fix the rotational position of the shaft 60, 61 relative to the outer housing 58, 59, respectively.

The outer housing 58 of the proximal riser hinge 54 can be rigidly coupled to the base 20, and the shaft 60 of the proximal riser hinge 54 can freely rotate relative to the outer housing 58 when the set screw(s) 62 are loosened. The proximal riser hinge 54 can also be configured such that the shaft 60 of the proximal riser hinge 54 is coupled to the base 20 and the outer housing 58 of the proximal riser hinge 54 is freely rotatable about the shaft 60 when the set screw(s) 62 are loosened from engagement with the shaft 60. The outer housing 58 or shaft 60 of the proximal riser hinge 54 can be coupled to the base 20 by welding, sintering, adhering with an adhesive, fastening with one or more fasteners, or other coupling means.

The proximal end 50 of the extension 48 is coupled to the outer housing 58 or shaft 60 of the proximal riser hinge 54 to allow the riser to pivot about center axis A of the proximal riser hinge 54. The proximal end 50 of the extension 48 can be coupled to the outer housing 58 or shaft 60 of the proximal riser hinge 54 by welding, sintering, adhering with an adhesive, fastening with one or more fasteners, press-fitting, interference fitting, or other methods of attachment. The proximal riser hinge 54 can allow the riser 44 to pivot more than 180° relative to the base 20. When the base 20 is coupled to a flat surface, such as the floorboard of a vehicle, the flat surface of the vehicle may limit rotation of the riser 44 to about 180° or less. Pivoting the riser 44 about the center axis A of the proximal riser hinge 54 changes the height H (FIG. 3) of the cradle 24 relative to the base 20. Rotating the riser 44 generally 90° relative to the base 20 can place the cradle 24 at a maximum height from the base 20.

In one embodiment, the riser extension 48 can include two bars 64, the bars 64 being oriented generally parallel to each other and each bar 64 coupled to the outer housing 58 or the shaft 60 of the proximal riser hinge 54 at the proximal end 50 of the extension 48 and coupled to the outer housing 59 or the shaft 61 of the distal riser hinge 56 at the distal end 52 of the riser extension 48 (FIGS. 3-5). In another embodiment, the riser extension 48 can be a generally flat plate having portions that couple to the outer housings 58, 59 or the shafts 60, 61 of each of the proximal 54 and distal 56 riser hinges, respectively (FIG. 1). The riser 44 can have one or more apertures 66 (FIG. 3) extending therethrough to reduce the weight and material cost of the riser 44. In an embodiment (not shown), the riser 44 can include one or more supplemental riser extensions and one or more supplemental riser hinges coupling together the supplemental riser extensions and coupling the supplemental riser extensions to the riser extension.

Referring to FIG. 5, the distal end 52 of the riser extension 48 can be coupled to the distal riser hinge 56, which can have central axis B that is generally parallel to the center axis A of the proximal riser hinge 54. The distal end 52 of the riser extension 48 can be coupled to the outer housing 59 or the shaft 61 of the distal riser hinge 56. The outer housing 59 can include one or more set screws 62 to set the rotational position of the shaft 61 of the distal riser hinge 56 relative to the outer housing 59. The distal riser hinge 56 can provide up to 360° of rotation of the cradle 24 relative to the riser 44. In one embodiment, the cradle 24 and positioning bracket 46 may limit the range of motion of the cradle 24 to about 270° or less.

The housing 59 of the distal riser hinge 56 can also include at least two threaded apertures 68 for receiving fasteners for mounting the positioning bracket 46 to the outer housing 59 of the distal riser hinge 56 and rotationally positioning the positioning bracket 46 relative to the distal riser hinge 56. Each of the threaded apertures 68 can be spaced apart from one another but positioned along a line generally parallel to the center axis B of the distal riser hinge 56. The threaded apertures 68 can be radially spaced apart from the set screws 62 of the distal riser hinge 56 so that the positioning bracket 46 does not interfere with tightening and loosening the set screws 62.

Referring back to FIG. 4, the positioning bracket 46 can include a pivot plate 70 coupled to a positioning hinge 72. The pivot plate 70 is coupled to an outer housing 74 of the positioning hinge 72 by welding, sintering, adhering with an adhesive, fastening with one or more fasteners, or other coupling means. The positioning bracket 46 can be removably coupled to the distal riser hinge 56 by way of the pivot plate 70 and can be coupled to the cradle 24 at the positioning hinge 72.

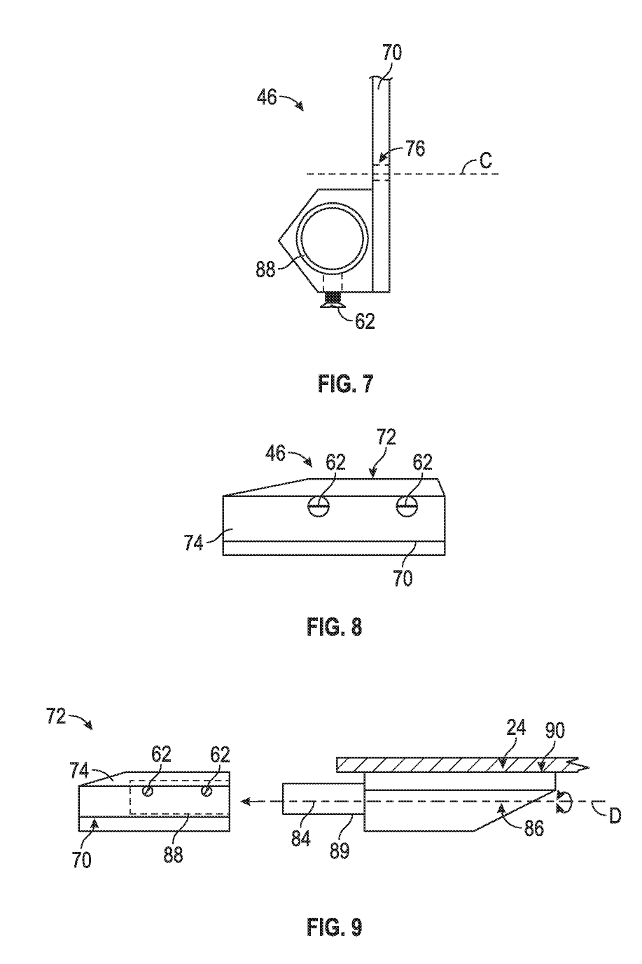

Referring to FIGS. 6-8, the pivot plate 70 can be a generally flat plate having an aperture 76 for receiving a pivot fastener 78 for mounting the pivot plate 70 to the distal riser hinge 56. The pivot fastener 78 is received through the aperture 76 in the pivot plate 70 and received into one of the threaded apertures 68 (FIG. 5) in the housing 59 of the distal riser hinge 56. The aperture 76 defines a pivot axis C of the pivot plate 70 relative to the distal riser hinge 56. The pivot plate 70 can also include a generally arcuate aperture 80 for receiving another fastener 82 for fixing the rotational position of the pivot plate 70 relative to the distal riser hinge 56. The other fastener 82 is received through the arcuate opening 80 in the pivot plate 70 and in another of the threaded apertures 68 (FIG. 5) in the outer housing 59 of the distal riser hinge 56.

Referring to FIG. 6, with the pivot fastener 78 and the other fastener 82 slightly loosened, the pivot plate 70 can be rotated about pivot axis C such that a position of the other fastener 82 within the arcuate aperture 80 changes. Rotation of the pivot plate 70 about axis C is indicated by the arrows in FIG. 6. Rotation of the pivot plate 70 in combination with the rotational position of the distal riser hinge 56 can orient the cradle 24 vertically relative to the base 20. When the cradle 24 is oriented, the pivot fastener 78 and other fastener 82 can be tightened to reversibly fix the rotational position of the pivot plate 70 relative to the distal riser hinge 56.

Referring to FIG. 9, the positioning hinge 72 comprises the outer housing 74, a shaft 84, and an attachment portion 86 coupled to the shaft 84. The housing 74 is coupled to the pivot plate 70 and has a central bore 88 therein configured to receive the shaft 84. The shaft 84 is removably and rotatably received within the central bore 88 of the housing 74 such that the shaft 84 and the attachment portion 86 can be capable of rotating about an axis D. The attachment portion 86 is coupled to an end 89 of the shaft 84 protruding from the housing 74. The attachment portion 86 includes an attachment surface 90 for attaching the positioning hinge 72, and thus the distal end 42 of the arm 22, to the cradle 24. The attachment surface 90 of the positioning hinge 72 can be attached to the cradle 24 by welding, sintering, adhering with an adhesive, fastening with one or more fasteners, or other coupling means. The outer housing 74 can include one or more set screws 62 to reversibly fix the rotational position of the shaft 84 within the housing 74. Rotation of the shaft 84 of the positioning hinge 72 relative to the housing 74 can rotationally orient the cradle 24 in a plane generally perpendicular to the axis D.

Each of the components making up the arm 22, including the riser hinges 54, 56, riser extension 48, and positioning bracket 46, can be made of rigid and durable materials, such as, for example, carbon fiber, fiberglass, or metal, such as steel, iron, aluminum, titanium, brass or other metal or metal alloy. The components of the arm 22 can also be made from a rigid and/or durable thermoplastic or polymer, such as ABS, PE, HDPE, LDPE, PP, polyamide, PS, PVC, or other rigid or durable plastic/polymeric materials or composite materials.

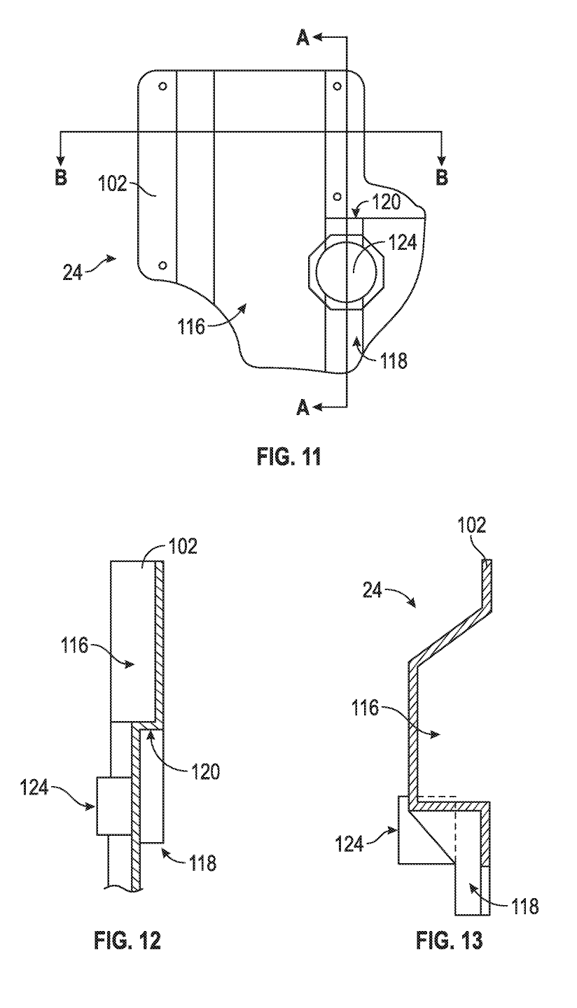

Referring to FIGS. 3-4 and 10-12, the cradle 24 can include an outer shell 102 having an inner surface 104 defining an inner cavity 106 passing vertically into and/or through the cradle 24 and shaped/adapted to receive the barrel 14 of the firearm 12 (FIG. 4). The outer shell 102 can be made of one piece or two or more separate pieces that are coupled together by a plurality of fasteners 108, such as bolts. In one embodiment, the outer shell 102 fully surrounds an end 13 of the barrel 14 of the firearm 12 when the firearm 12 is inserted within the cradle 24. In another embodiment, the inner cavity 106 passes all the way through the outer shell 102 so that the outer shell 102 does not completely surround the barrel 14 of the firearm 12. The outer shell 102 of the cradle 24 can be made of rigid and durable materials, such as, for example, carbon fiber, fiberglass, or metal, such as steel, iron, aluminum, titanium, brass or other metal or metal alloy. The outer shell 102 can also be made from a rigid and/or durable thermoplastic or polymer materials, such as ABS, PE, HDPE, LDPE, PP, polyamide, PS, PVC, or other rigid or durable plastic/polymeric materials or composite materials. The outer shell 102 of the cradle 24 can be coupled to the attachment surface 90 of the positioning hinge 72 by welding, sintering, adhering with an adhesive, fastening with one or more fasteners, or other coupling means.

Referring to FIGS. 3 and 10, the outer shell 102 can be widened to receive an insert 110 having an outer surface 112 shaped to fit securely within the outer shell 102. The insert 110 can include an inner surface 114 defining the inner cavity 106 of the cradle 24. The insert 110 can be a single molded piece or can be a plurality of pieces coupled together within the outer shell 102 by the one or more fasteners 108. The insert 110 may also be coupled to the inner surface 104 of the outer shell 102 by adhering, press-fitting, interference fitting, clipping, or utilizing other mechanical methods of attachment. The insert 110 can be made of a thermoplastic or polymer, such as ABS, PE, HDPE, LDPE, PP, polyamide, PS, PVC, or other rigid or durable plastic/polymeric materials or composite materials. In an embodiment, the insert 110 is made of a material having a hardness that is less than a hardness of a material of the firearm 12 (or finish coatings on the firearm) so that the insert 110 does not scratch or otherwise deform the surface finish of the firearm 12 while inserting and removing the firearm 12 from the cradle 24. In an embodiment, the insert 110 is made of ABS.

The inner surface 106 of the outer shell 102, or the inner surface 114 of the insert 110, can define the inner cavity 106 to have a widened portion 116 for receiving a portion of the barrel 14 of the firearm 12 and optionally a narrowed portion 118 of the cavity 106 for receiving at least a portion of the trigger guard 16 of the firearm 12. The inner surface 104 of the outer shell 102 can have an abutment 120 against which the trigger guard 16 of the firearm 12 is seated when the firearm 12 is inserted into the inner cavity 106. The abutment 120 can be positioned to orient the firearm 12 within the inner cavity 106 such that the locking mechanism 28 can engage the trigger guard 16 of the firearm 12. In an embodiment, the inserted position of the firearm 12 in the cradle 24 can be determined by abutment of the handle 15 of the firearm 12 against a top edge 122 of the cradle 24. When the firearm 12 is positioned barrel 14 downward within the cradle 24, in the inserted position, at least a portion of the trigger guard 16 and trigger 17 (FIG. 1) are positioned within the inner cavity 106 and generally between opposing inner surfaces 104 of the outer shell 102 and/or between opposing inner surfaces 114 of the insert 110. In this position, the handle 15 of the firearm 12 protrudes from the cradle 24 so that the handle 15 can be gripped by the user to insert and remove the firearm 12 from the cradle 24. The shape of the inner cavity 106 can be designed to accommodate the outer contour of a specific make and model of firearm 12. In an embodiment, the cradle 24 can include a universal outer shell 102, and the insert 110 can be shaped to define the inner cavity 106 of a specific shaped for a particular make and model of firearm 12. In an embodiment, the cradle 24 having a universal outer shell 102 can be adapted to fit different models of firearm by changing the insert 110.

Referring to FIGS. 10-12, the outer shell 102, and optionally the insert 110, can have a side bore 124 sized to receive the locking mechanism 28 therethrough. The side bore 124 extends through one side 126 of the outer shell 102 and insert 110 in a direction generally perpendicular to a midplane E (FIGS. 3 and 10) of the cradle 24. The side bore 124 is positioned so that the side bore 124 provides access to a space 128 defined by the trigger guard 16 when the firearm 12 is inserted in the cradle 24. In an embodiment, the side bore 124 is positioned adjacent to the narrow portion 118 of the inner cavity 106 of the cradle 24. The side bore 124 receives a portion of the locking mechanism 28 therein to enable the locking mechanism 28 to engage the trigger guard 16 of the firearm 12 when in a locked position.

Referring to FIG. 10, the locking mechanism 28 can include a locking member 30 and a solenoid 132 that operates to move the locking member 30 into and out of a locking position. The locking member 30 can be a pin, hook, or other structure that is capable of being positioned through or engaging with the trigger guard 16 of the firearm 12. When in a locking position, the locking member 30 may extend through the space 128 defined by the trigger guard 16. The locking member 30 may pass between the trigger guard 16 and the trigger 17 or between the trigger 17 and the handle 15. The locking mechanism 28 can include a spring 134 or other biasing member that biases the locking member 30 into the locking position when the solenoid 132 is not energized. In one embodiment, the solenoid 132 can be a 12 V DC solenoid.

When energized, the solenoid 132 can operate to move the locking member 30 laterally (i.e., along a line generally perpendicular to the midplane E of the cradle 24) out of the locking position and into an unlocked position, in which state the locking member 30 is no longer engaged with or inserted through the trigger guard 16 of the firearm 12. When the solenoid 132 is activated and the locking member 30 is moved out of the locking position, the firearm 12 may be removed from or inserted into the cradle 24. When the solenoid 132 is de-energized, the solenoid 132 releases the locking member 30, which is then biased back into the locking position by the spring 134 (biasing member).

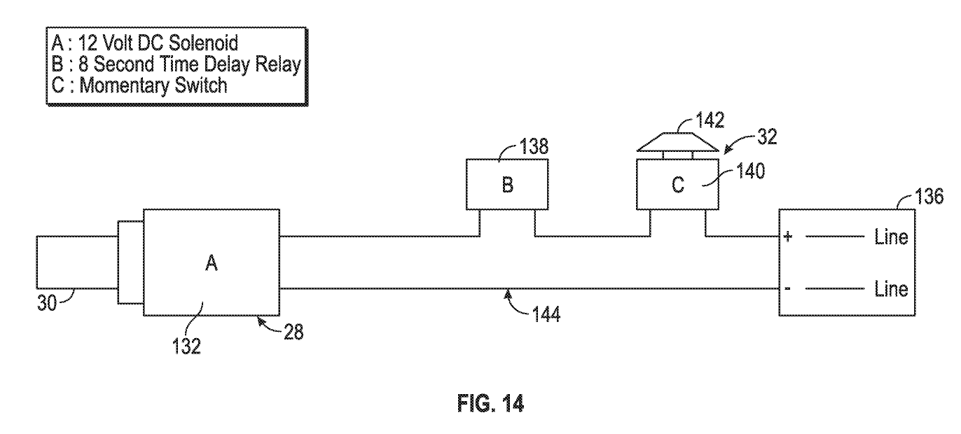

Referring to FIG. 14, the solenoid 132 of the locking mechanism 28 can be electrically coupled to a power source 136. The power source 136 can be one or more batteries, such as one or more 12 V batteries, or the power source 136 can be the power system in the vehicle 18 in which the firearm retention device 10 is installed. In one embodiment, the power source 136 is the 12 V 10 amp DC system of the vehicle 18. The solenoid 132 of the locking mechanism 28 can also be electrically coupled to a time delay relay 138, which can be configured to energize the solenoid 132 for a specified period of time before de-energizing the solenoid 132, in which state the solenoid 132 releases the locking member 30, which is then biased back into the locking position. The specified period of time can be selected to provide sufficient time to insert or remove the firearm 12 from the cradle 24. In one embodiment, the time delay relay 138 is an 8 second time delay relay.

The solenoid 132 of the locking mechanism 28 can also be electrically coupled to a switch 140 that energizes the solenoid 132 when activated. The switch 140 can include one or more user input devices 142, such as a push button, toggle switch, lever, fingerprint reader, or other input device, for example. In an embodiment, the switch 140 can be electrically coupled to one or more control circuits of the vehicle 18 such that the solenoid 132 can be operated in response to operating conditions of the vehicle 18, such as energizing the solenoid 132 only when the vehicle 18 is stopped. In an embodiment, the switch 140 can be a momentary switch. FIG. 14, shows an schematic of a circuit 144 that includes the solenoid 132 of the locking mechanism, the power source 136, the time delay relay 138, and the switch 140 operatively coupled to a push button 142.

Referring back to FIG. 2, the firearm retention device 10 can be installed on a surface 19, such as a floor, of a vehicle 18 by using fasteners 36 to couple the base plate 20 to the surface 19. The various pivot points (e.g., hinges 54, 56, 72 and pivot plate 70) can be adjusted to place the cradle 24 in a position to provide efficient and/or ergonomic access to the firearm 12 by the user. The pivot points can be fixed in position by the various set screws. The solenoid 132 of the locking mechanism 28 can be wired to the power source 136, switch 140, and time delay relay 138 (FIG. 14). The switch 140 with the user input device 142 (e.g., push button) can be positioned within the vehicle 18. The position of the user input device 142 can be selected to provide convenient access to the user input device 142 and switch 140 or to conceal the user input device 142 and switch 140 from persons outside or inside the vehicle 18. Positions within the vehicle 18 for the switch 140 can include, but are not limited to, the dashboard, steering column, center console, under the dashboard, under the seat, in the ceiling, or in any other convenient or concealing position.

To remove the firearm 12 from or insert the firearm 12 into the cradle 24, the user activates the user input device 142 operatively coupled to switch 140, which energizes the locking mechanism 28. The solenoid 132 of the locking mechanism 28 retracts the locking member from the trigger guard 16 of the firearm 12. The user can then insert or remove the firearm 12 from the cradle 24. In an embodiment, the user can press and hold the user input device 142 while removing the firearm 12 from the cradle 24. In an embodiment, the user can activate the switch 140, and the time delay relay 138 can hold the solenoid 132 in the unlocked position for the specified period of time while the user inserts or removes the firearm 12.

A method of securing a firearm 12 within a vehicle 18 can include providing a firearm retention device 10 as disclosed herein, installing the firearm retention device 10 within the vehicle 18 as described herein, activating the switch 140 to open the solenoid 132 of the locking mechanism 28, inserting the firearm 12 within the cradle 24 of the firearm retention device 10 such that the firearm 12 is fully seated within the cradle 24, and releasing the switch 140 or allowing the time delay relay 138 to de-energize the solenoid 132 to allow the locking member 30 of the locking mechanism 28 to move into the locking position.

It is to be clearly understood that the above description is intended by way of illustration and example only, is not intended to be taken by way of limitation, and that other changes and modifications are possible.

What is claimed is:

1. A firearm retention device comprising:
a base;
an arm coupled to the base and pivotable about an axis of rotation;
a cradle coupled to an end of the arm opposite the base and having an inner cavity shaped to receive a firearm therein; and
a locking mechanism having a locking member, wherein the locking mechanism is positioned so that the locking member extends into a space formed by a trigger guard of the firearm when the firearm is received in the cradle and the locking member is moved to a locking position.

2. The firearm retention device of claim 1 wherein the arm has three pivot points about which the arm is pivotable.

3. The firearm retention device of claim 1 wherein the arm comprises:
a riser pivotably coupled to the base;
a bracket pivotably coupled to the riser; and
a hinge pivotably coupled to the bracket.

4. The firearm retention device of claim 1 wherein the cradle has a first open end configured to receive a firearm and a second open end opposite the first open end and through which the barrel of the firearm protrudes.

5. The firearm retention device of claim 1 wherein the cradle further comprises a rigid outer shell and an insert positioned within the outer shell and shaped to receive the firearm.

6. The firearm retention device of claim 1 wherein the locking mechanism includes a solenoid coupled to the locking member, wherein the solenoid moves the locking member out of the locking position when activated.

7. The firearm retention device of claim 6 wherein the locking mechanism includes one or more electrical connections for providing power from the vehicle to the locking mechanism.

8. The firearm retention device of claim 6 further comprising a battery receptacle for receiving one or more batteries to provide power for the solenoid.

9. A firearm retention device comprising:
a mounting base;
a riser pivotably coupled to the base about a first axis;
a hinge pivotably coupled to the riser about a second axis, wherein the second axis is substantially parallel to the first axis;
a mounting bracket pivotably coupled to the hinge about a third axis, wherein the third axis is substantially perpendicular to the second axis;
a cradle having an inner cavity shaped to receive a firearm therein, the cradle pivotably coupled to the mounting bracket about a fourth axis, wherein the fourth axis is substantially perpendicular to the third axis and the second axis; and
a locking mechanism having a locking member movable between a locking position and an unlocking position, wherein the locking member is received within a trigger guard of the firearm when the firearm is received in the cradle and the locking member is moved to the locking position.
